(19) United States
(12) Patent Application Publication
(10) Pub. No.: US 2016/0013712 A1
(43) Pub. Date: Jan. 14, 2016

(54) METHODS AND APPARATUS FOR COMPACT SERIES LINEAR ACTUATORS

(71) Applicant: Systems, Machines, Automation Components Corporation, Carlsbad, CA (US)

(72) Inventors: Edward A. Neff, Cardiff-by-the-Sea, CA (US); Toan M. Vu, San Diego, CA (US)

(21) Appl. No.: 14/678,717

(22) Filed: Apr. 3, 2015

Related U.S. Application Data
(60) Provisional application No. 61/975,621, filed on Apr. 4, 2014.

(51) Int. Cl. H02K 41/02

(52) U.S. Cl. CPC H02K 41/02

(57) ABSTRACT

Serial linear actuators that are compact in size and can operate at high speeds with reduced failure rates. The disclosed linear actuators may be used in sub micron positioning applications such as, for example, in semiconductor or biotechnology scanning applications. An actuator apparatus may include a magnet housing which defines an interior volume in which a permanent magnet and a moving coil assembly are disposed. The moving coil assembly includes electrically conductive coils wound around a set of substantially flat moving coil scaffolds. The moving coil assembly is centrally located within the actuator between a set of outer cross roller guides to reduce or eliminate the internal moment effect of the coil on the guiding system of the actuator and to allow the actuator to have a small height and compact form factor.

### CROSS-REFERENCE TO RELATED APPLICATIONS

The present application claims the benefit of priority under 35 U.S.C. §119(e) of U.S. Provisional Application Ser. No. 61/975,621, entitled METHODS AND APPARATUS FOR COMPACT SERIES LINEAR ACTUATORS, filed Apr. 4, 2014, the content of which is hereby incorporated by reference in its entirety for all purposes.

### BACKGROUND

This disclosure relates generally to moving coil actuators and, more particularly to compact series linear actuators (SLA) and methods for making the same.

Linear actuators are mechanical devices that transform electrical energy into mechanical energy to perform repetitive actions requiring linear motion. For example, linear actuators can be used in an assembly plant for placing caps on bottles, for automatically stamping or labeling mail, for glass cutting, for placing chips on circuits, and/or the like. Linear actuators can also be used for a wide variety of sub-micron positioning applications such as semiconductor scanning applications (e.g., testing various devices fabricated on semiconductor wafers) or for biotechnology-related scanning applications (e.g., single bio-molecule detection).

Accordingly, a need exists for improved compact linear actuators that can fit into compact scanning heads and can operate reliably with high resolution, speed, smooth motion and reduced failure rates.

### SUMMARY

The serial linear actuators disclosed herein are compact in size and can operate at high speeds with reduced failure rates. The disclosed linear actuators may be used, for example, in sub micron positioning applications such as, for example, semiconductor or biotechnology-related scanning.

Embodiments of the disclosed linear actuators may include a magnet housing configured to define an interior volume. A permanent magnet and a moving coil assembly are disposed within the interior volume. A moving coil assembly includes electrically conductive coils wound around a set of substantially flat moving coil scaffolds. The moving coil assembly is centrally located between a set of outer cross roller guides to reduce or eliminate the internal moment effect of the coil on the guiding system of the actuator and to allow the actuator to have a very compact size.

In a particular aspect the disclosure relates to a linear actuator including a magnet housing, a moving slide assembly and a moving coil assembly coupled to the moving slide assembly. The moving slide assembly includes a moving slide housing coupled to one or more cross roller guides. The magnet housing defines an interior volume between a first end and a second end and may include a first end plate at the first end and a second end plate at the second end. The linear actuator includes at least one magnet coupled to an interior surface of the magnet housing. The moving coil assembly includes at least one coil received within the interior volume of the magnet housing. The linear actuator may further include a linear encoder assembly having a linear guide coupled to the moving slide assembly. During operation of the linear actuator, the moving slide assembly moves parallel to a longitudinal axis intersecting the first and second ends of the magnet housing.

In one implementation the moving coil assembly includes a plurality of coils received within the interior volume and a plurality of scaffold structures configured to support the plurality of coils.

In another aspect the disclosure relates to linear actuator including a magnet housing having a first end and a second end. The magnet housing defines a planar interior surface and an interior volume between the first end and the second end. At least one planar magnet is coupled to the planar interior surface. The linear actuator further includes a moving slide assembly including a first plurality of cross roller guides. A second plurality of cross roller guides may also be provided where the first plurality of cross roller guides are configured to move relative to the second plurality of cross roller guides. A moving coil assembly is operably coupled to the moving slide assembly. The moving coil assembly includes at least one coil received within the interior volume of the magnet housing.

The disclosure also pertains to a linear actuator including a magnet housing having a first end and a second end. The magnet housing defines an interior surface and an interior volume between the first end and the second end. At least one magnet is coupled to the interior surface. The linear actuator also includes a moving slide assembly which may include a moving slide housing coupled to a pair of cross roller guides. A moving coil assembly is operably coupled to the moving slide assembly and includes at least one coil received within the interior volume of the magnet housing. The at least one coil may be wound around a flat moving coil scaffold.

### BRIEF DESCRIPTION OF THE DRAWINGS

FIG. 1 is a perspective view of a series linear actuator, according to an embodiment.

FIG. 2 is an exploded perspective view of the series linear actuator of FIG. 1.

### DETAILED DESCRIPTION

Apparatus and methods for a compact, low cost, and lightweight series linear actuator are described herein. Embodiments of the disclosed linear actuators may fit into compact scanning heads and operate reliably with high resolution, speed and with reduced failure rates such that overall cost to a user can be reduced.

Actuators that are used in sub-micron positioning applications such as in semiconductor scanning applications (e.g., testing various electronic or photonic devices fabricated on semiconductor wafers) or in biotechnology-related scanning applications (e.g., single bio-molecule detection, DNA sequencing, etc.) need to meet several strict dimensional and performance criteria. Such criteria include, for example, having small package size (e.g., being within approximately 20 mm in height); having sturdy guides with significant stiffness that can reduce unwanted movement caused by internally generated or externally generated vibrations and can limit movement to less than 150 nm; allowing for smooth motion with low friction; allowing for fast movement over strokes ranging from microns to tens of millimeters; and/or having a relatively low height.

Serial linear actuators are described herein that are compact in size and can operate at high speeds with reduced failure rates. Exemplary embodiments of such a linear actuator include a magnet housing defining an interior volume between a first end and a second end. The interior volume includes a permanent magnet and a moving coil assembly that includes a set of electrically conductive coils wound around a set of substantially flat moving coil scaffolds. In such embodiments, the permanent magnets are adapted to magnetically interface with the moving coil assembly when a magnetic field is present in the coils of the moving coil assembly. Current is introduced through the coils during operation of the actuator, thereby creating a magnetic field having a direction that depends on the direction that the current is flowing through the coils. The magnitude of the magnetic field corresponds to the number of turns associated with each coil and the amperage conducted through the conductive material. In such embodiments, by repeatedly alternating the direction that current is flowing through the coils of the moving coil assembly, a linear force may be repeatedly imparted upon the moving coil assembly thus making the moving coil assembly move in a linear fashion back and forth across the length of the actuator.

As used herein, the singular forms “a,” “an” and “the” include plural referents unless the context clearly dictates otherwise. Thus, for example, the term “a coil” is intended to mean a single coil or multiple coils.

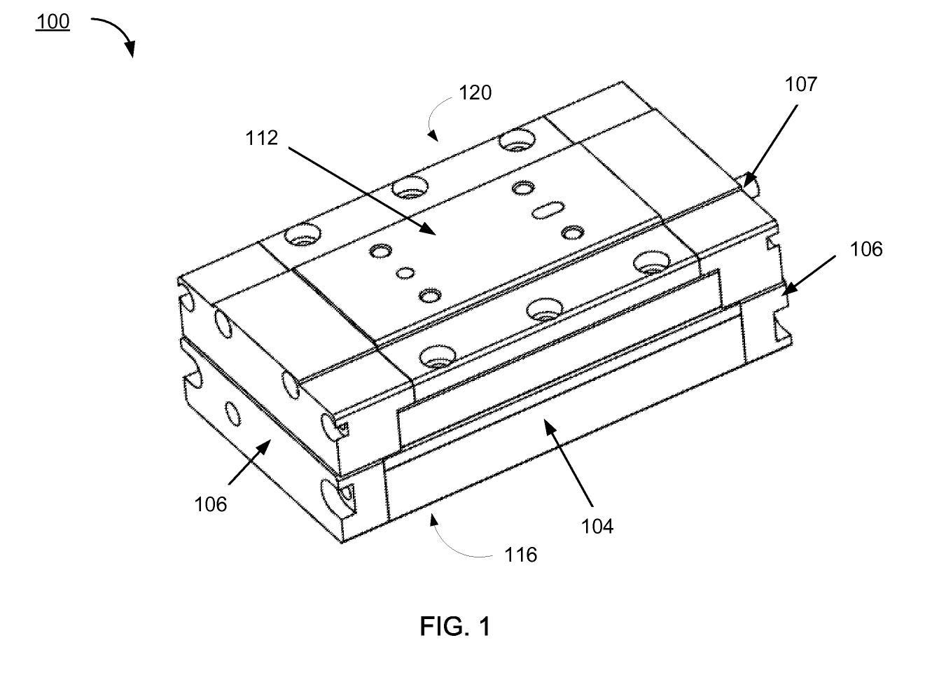

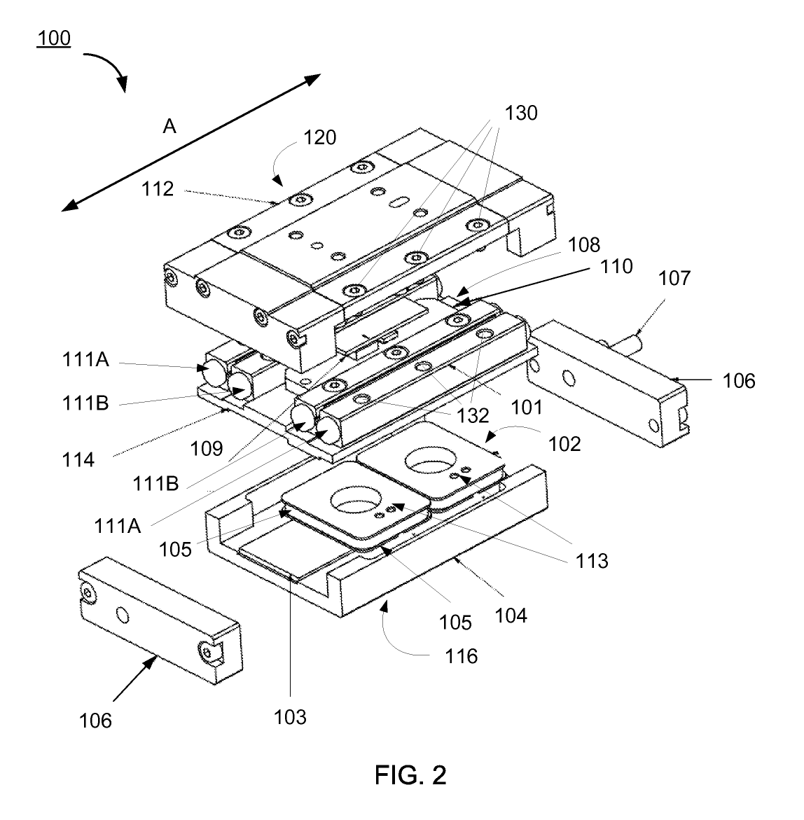

FIG. 1 is a perspective view of a series linear actuator, according to an embodiment. As shown in FIG. 1, the series linear actuator 100 (also referred to herein as “actuator”) can include a moving slide assembly 120, a magnet housing assembly 116 including a set of end plates 106, a moving coil assembly (not shown in FIG. 1), and an electrical connector 107. The magnet housing assembly 116 can include a magnet housing 104 and one or more permanent magnets 103 (not shown in FIG. 1). Each of these components is discussed is presented and discussed in greater detail in relation to FIG. 2 below.

FIG. 2 is an exploded perspective view of the series linear actuator of FIG. 1. As shown in FIG. 2, the series linear actuator 100 includes a moving coil assembly 102 centrally located within an interior volume defined by the magnet assembly 116. The moving slide assembly 120 may include a moving slide housing 112 coupled to outer cross roller guides 111A. The moving slide assembly 120 may be coupled to the moving coil assembly 102. During operation of the linear actuator 100, the slide housing 112, outer cross roller guides 111A and moving coil assembly 102 may move back and forth parallel to a longitudinal axis A. This movement occurs relative to a pair of fixed, inner cross roller guides 111B coupled to a fixed support plate 114. In one embodiment the fixed support plate 114 is coupled to the magnet housing assembly 116. The slide housing 112 may be coupled to the outer cross roller guides 111A by a set of screws 130 received by recesses 132.

The cross roller guides 111 may be obtained from, for example, IKO Inc. (e.g., part no. CRWG2-45). Although in the embodiment of FIG. 2 a set of four cross roller guides 111 are employed, other embodiments can include more or less than four cross roller guides 111. Each of the cross roller guides 111 can incorporate a rack and pinion option that can prevent cage creep when the actuator 100 is operating in a non-horizontal orientation. The relative location of the moving coil assembly 102 centrally with respect to the set of cross roller guides 111 eliminates or reduces the internal moment effect of the coil on the set of cross roller guides 111. This relative location can also facilitate a significantly compact design, particularly with respect to the thickness of the actuator 100, which can be as small as, for example, 10 mm, and thus can easily fit into various different scanning heads used in, for example, the semiconductor industry and/or the biotechnology industry. In some embodiments, the actuator 100 can include a set of cross roller guides 111 that are exposed. In other embodiments the actuator 100 can include a set of cross roller guides 111 that are at least partially enclosed by the moving slide assembly 120.

The moving coil assembly 102 can include a coil or a set of coils (not shown in FIG. 2) wound around a set of substantially flat moving coil scaffolds 113. The moving coil assembly 102 is located centrally in the actuator 100 between outer cross roller guides 111A of the magnet housing assembly 116. As shown in FIG. 2, the moving coil assembly 102 can be made up of either one or two coils that are wired as a single pole actuator. In other embodiments, the moving coil assembly 102 can include a three coil unit (not shown in FIG. 2) that is wired to run, for example, as a multi-pole unit. The single pole unit can stroke up to, for example, 25 mm while the three coil setup can stroke up to, for example, 100 mm.

The coil scaffold 113 of the moving coil assembly 102 can support an electrically conductive medium such as, for example, an electrically conductive coil (not shown in FIGS. 1 and 2). During operation of the actuator 100, current is introduced through the coil(s) thereby creating a magnetic field having a direction that depends on the direction that the current is flowing through the coil. The magnitude of the magnetic field corresponds to the number of turns associated with each coil and the amperage conducted through the conductive material. For example, in some embodiments, a coil can include 74 turns per coil, but it should be understood that any number of turns per coil may be used. In some embodiments, the coil may have, for example, a resistance of approximately 1.7 Ω, 6.8 Ω per phase, and can be fabricated with a 29 gauge copper wire. Such specifications are only exemplary. It should be understood that any type of conductive material with varying specifications can be used. It should further be understood that the coils may be electrically connected to a power source and/or connected together in any manner known in the electrical and mechanical arts. In some embodiments, coil scaffold 113 can be formed with a low cost, plastic material to reduce the overall mass of the moving coil assembly 102.

The magnet housing assembly 116 can include the magnet housing 104, one or more permanent magnets 103 and end plates 106. The permanent magnets 103 can be, for example, substantially rectangular and flat magnets as shown in FIG. 2, and can be coupled to an interior wall of the magnet housing 104. For example, the permanent magnets 103 can be coupled to the magnet housing 104 during manufacturing with various adhesives and/or screws. The permanent magnets 103 can be adapted to magnetically interface with the moving coil assembly 102 when a magnetic field is present in the coils of the moving coil assembly 102. Hence, by repeatedly alternating the direction that current is flowing through the coils of the moving coil assembly 102, a linear force may be repeatedly imparted upon the moving coil assembly 102, thus making the moving coil assembly 102 (and moving slide assembly 120 coupled thereto) move in a linear motion back and forth along the length or longitudinal axis A of the actuator 100.

For example, in some instances, when the direction of the direct electric current (DC) flowing through the coils induces a temporary magnetic field in the coils of the moving coil assembly 102 that is of the same polarity of the magnetic field of the permanent magnets 103, the moving coil assembly 102 moves in a direction away from the permanent magnet 103 (i.e., is repulsed away from the permanent magnet 103). In other instances, when the direction of the DC electric current flowing through the coils induces a temporary magnetic field in the coils of the moving coil assembly 102 that is of the opposite polarity of the magnetic field of the permanent magnets 103, the moving coil assembly 102 moves in a direction towards the permanent magnet 103 (i.e., is attracted towards the permanent magnet 103). Because the moving slide assembly 120 is operably coupled to the moving coil assembly 102, movement of the moving coil assembly 102 (in either direction with respect to the permanent magnet 103) also induces a movement of the moving slide assembly 120 in conjunction with the moving coil assembly 102.

The total mass of the moving components of the actuator 100 (e.g., moving slide assembly 120 and the moving coil assembly 102) can depend on the size of the actuator 100 and is typically significantly light (e.g., on the order of 25 to 50 grams depending on the size of the unit). Because the current flowing through the coils of the moving coil assembly 102 while in motion can be kept at relatively low levels (e.g., in the 1-1.5 Amp range), the actuator 100 with moving parts does not generate much heat. At this current range, a force of 10-15 times the moving mass of the actuator 100 can be achieved in every stroke, and hence the acceleration of every stroke can be up to 10-15 G. This is sufficient to make fast movements in both short and longer stroke applications.

In alternative embodiments, the actuator 100 can be provided with a shaft rather than a slide. For example, a shaft version of an actuator that can incorporate some or all of the features described herein is described in U.S. provisional application no. 61/898,140,entitled “Apparatus and Methods for Low Cost Linear Actuator” and having Attorney Docket No. SMAC-011/00US, filed on Oct. 31, 2013, the disclosure of which is incorporated herein by reference in its entirety.

The linear encoder assembly 108 includes a linear encoder feedback scale 109 and a linear feedback scale read head 110. The read head 110 may remain fixed and be coupled to, for example, the inner roller guides 11B and the support plate 114. The feedback scale may be coupled to moving slide housing 112. The linear encoder assembly 108 can also include a feedback circuitry (not shown in FIG. 2) along with the linear encoder feedback scale 109 for indicating linear positional feedback to, for example, a controller (such as a remote computer). In some configurations, the linear encoder assembly 108 may include an encoder housing that can be coupled to the moving slide assembly 120 using, for example, a threaded fastener, such as, for example, screws. In such configurations, the linear encoder assembly 108 can thus remain fixed with respect to the moving slide assembly 120 as the moving slide assembly 120 is repeatedly actuated. In some embodiments, the encoder housing can be disposed within, for example, a cutout (not shown in FIG. 2) in the support plate 114. The linear feedback scale read head 110 (e.g., a sensor, a transducer etc.), can be paired with the linear encoder feedback scale 109 that can encode position. The linear feedback scale read head 110 can read the linear encoder feedback scale 109 and convert the encoded position into an analog or digital signal. This in turn can then be decoded into position data by a digital readout (DRO) or motion controller (not shown in FIGS. 1 and 2). The linear encoder assembly 108 can work in either incremental or absolute modes. Motion can be determined, for example, by change in position over time. Linear encoder technologies can include, for example, optical, magnetic, inductive, capacitive and eddy current. Optical linear encoders are common in the high resolution market (e.g., the semiconductor industry market and/or the biotechnology industry market) and can employ shuttering/Moiré, diffraction or holographic principles. Typical incremental scale periods can vary from hundreds of micrometers down to sub-micrometer, and following interpolation can provide resolutions as fine as 1 nm. The linear encoder assembly 108 shown in FIG. 2 can have a resolution in the range of, for example, 5 microns to 50 nm. In other embodiments, finer resolution encoders can also be incorporated providing resolutions up to, for example, 1 nm.

The linear encoder feedback scale 109 may include a series of stripes or markings running along a length of the linear encoder feedback scale 109. When the moving coil assembly 102 is actuated, the linear feedback scale read head 110 (e.g., an optical reader) can count the number of stripes or markings read in order to determine the current linear position of the moving coil assembly 102. In some instances, the recorded positional data can be transmitted to a remote device for monitoring purposes. In some instances, a user can input one or more values to a remote device (such as a connected computer) in order to designate an amount of linear movement desired for a particular task (e.g., collecting optical signals from single bio-molecules in an ensemble sample for statistical analysis, analyzing a set of electrical devices fabricated on a silicon wafer, etc.). These values can then be transmitted to a controller (not shown in FIGS. 1 and 2) in electrical communication with the linear encoder assembly 108 via the electrical connector 107 such that linear movement of the moving coil assembly 102 can be adjusted according to the values specified. The actuator 100 may include any number of electrical connections and may include any number of electronic control sequences. Furthermore, in other embodiments, the actuator 100 may include any number of on-board digital control and/or analog circuitry known in the electrical arts. Additionally, in some embodiments, the actuator 100 may be remotely controlled to decrease the amount of on-board electric circuitry that can reduce the size of the actuator 100 and the cost of manufacturing the actuator 100.

In some embodiments, stroke variation and linear encoder resolution may be adjusted by the user, thereby reducing costs associated with reconfiguring and/or replacing the actuator 100. In addition, the actuator 100 may also include a number of programmable modes for adjusting, for example, position, force and speed of the moving coil assembly 102 during operation. Additionally, the linear encoder feedback assembly 108 can be matched with position, enabling the verification of work done by checking the position of the moving coil assembly 102 during the stroke of the actuator 100. The stroke can be, for example, a function of various assemblies of the actuator 100 (e.g., the magnet housing assembly 116, the moving slide assembly 120, and/or the end plates 106).

While FIG. 1 and FIG. 2 each depict an actuator with two coils, in other embodiments, the moving coil assembly 102 may include multiple coils supported by multiple separate scaffold structures 113 in the same moving coil assembly 102, as well as a magnet housing assembly 116 containing a series of alternately magnetized permanent magnets 103 (e.g., NS, SN, NS, etc.). The magnet housing assembly 116 and moving coil assembly 102 for such a multi-pole configuration can be implemented using standard machining processes. In some embodiments, the moving coil assembly 102 may include any number of coils. For example, to achieve a smaller stroke for a linear actuator 100, it may be desirable to use only one coil. Because coils can be expensive, using only one can save overall costs and can also reduce the size of the actuator 100. With a single coil, however, there may be less force at a set stroke value. Thus, (linear) actuators having more than one coil may be desired for tasks requiring higher stroke values. A single-coil actuator can offer simple control for strokes up to, for example, 25 mm. A multi-coil actuator, on the other hand, can offer larger stroke capabilities such as, for example, of up to 100 mm or more.

As discussed above, all or a portion of the manufactured parts of the actuator 100 described in FIGS. 1-2 can be machined on a CNC lathe such as the Hardinge model RS51MSY or other lathe that has the ability to machine one or both ends of a component (e.g., via sub-spindle transfer). According to some embodiments, each part can be made in a single operation on the lathe, thereby reducing and/or eliminating the need for secondary operations. These secondary operations can present additional costs and may also reduce quality by increasing dimensional variation. In some embodiments, the components of the actuator 100 may be manufactured from aluminum or steel. It should be understood, however that other suitable materials may also be used.

The actuator 100 described herein can be manufactured and assembled quickly and cost effectively. Further, the actuator 100 may be manufactured to be relatively small, lightweight, and compact and can be easily fit into the scan heads for devices used widely in the semiconductor industry and/or the biotechnology industry. Additionally, a linear encoder assembly 108 can provide monitoring and control over up to 100% of movement effected by actuator 100. Further, the individual designs of the end plates 106, the magnet housing assembly 116, and the moving coil assembly 102 can provide flexibility and easy reconfigurability during manufacturing such that various actuator configurations can be produced to conform to the specifications of a particular project.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A linear actuator, comprising:
a magnet housing including a first end and a second end, the magnet housing defining an interior volume between the first end and the second end;
at least one magnet coupled to an interior surface of the magnet housing;
a moving slide assembly including a first cross roller guide arranged parallel to a second cross roller guide; and
a moving coil assembly operably coupled to the moving slide assembly, the moving coil assembly including at least one coil received within the interior volume.

2. The linear actuator of claim 1 wherein the magnet housing further includes a first end plate at the first end and a second end plate at the second end.

3. The linear actuator of claim 1 wherein the first end and the second end are intersected by a longitudinal axis, the moving slide assembly being configured to move parallel to the longitudinal axis.

4. The linear actuator of claim 1 further including:
a support plate, and
at least one additional cross roller guide coupled to the support plate.

5. The linear actuator of claim 1 further including a third and fourth roller guides wherein the third and fourth roller guides are arranged parallel to the first cross roller guide and the second cross roller guide.

6. The linear actuator of claim 1 wherein the magnet housing further includes:
an end plate at the first end, and
an electrical connector supported by the end plate, the electrical connector being electrically coupled to the at least one coil.

7. The linear actuator of claim 1 further including a linear encoder assembly having a linear scale coupled to the moving slide assembly.

8. The linear actuator of claim 1 wherein the moving coil assembly includes:
a plurality of coils received within the interior volume, and
a plurality of scaffold structures configured to support the plurality of coils.

9. A linear actuator, comprising:
a magnet housing including a first end and a second end, the magnet housing defining a planar interior surface and an interior volume between the first end and the second end;
at least one planar magnet coupled to the planar interior surface;
a moving slide assembly including a first plurality of cross roller guides;
a second plurality of cross roller guides wherein the first plurality of cross roller guides are configured to move relative to the second plurality of cross roller guides; and
a moving coil assembly operably coupled to the moving slide assembly, the moving coil assembly including at least one coil received within the interior volume.

10. The linear actuator of claim 9 wherein the moving coil assembly is disposed between first and second cross roller guides of the first plurality of cross roller guides.

11. A linear actuator, comprising:
a magnet housing including a first end and a second end, the magnet housing defining an interior surface and an interior volume between the first end and the second end;
at least one magnet coupled to the interior surface;
a moving slide assembly wherein the moving slide assembly includes a moving slide housing coupled to a pair of cross roller guides; and
a moving coil assembly operably coupled to the moving slide assembly, the moving coil assembly including at least one coil received within the interior volume.

12. The linear actuator of claim 11 wherein the at least one coil is wound around a flat moving coil scaffold.

13. The linear actuator of claim 11 further including:
a support plate coupled to the magnet housing, and
at least one additional cross roller guide coupled to the support plate.
